(19) United States
(12) Patent Application Publication
(10) Pub. No.: US 2010/0199438 A1
(43) Pub. Date: Aug. 12, 2010

(54) COMPACT, MULTI-PURPOSE TOOL FOR WOMEN

(76) Inventors: GinaMarie Slattery, Tucson, AZ (US); Kris Johnson, Tucson, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/766,729

(22) Filed: Apr. 23, 2010

Related U.S. Application Data
(63) Continuation of application No. 11/873,915, filed on Oct. 17, 2007, now abandoned.
(60) Provisional application No. 60/829,726, filed on Oct. 17, 2006.

(51) Int. Cl. B26B 11/00

(52) U.S. Cl. 7/162

(57) ABSTRACT

A compact, portable multi-tool having top and bottom members connected to one another with a hinge mechanism. At least one of the top and bottom members includes a receptacle having a pivoting mechanism contained therein for attachment to a tool.

### CROSS-REFERENCE TO RELATED APPLICATIONS

This application is a continuation patent application based on utility patent application Ser. No. 11/873,915, filed Oct. 17, 2007, which claims priority to provisional patent application having Ser. No. 60/829,726, filed Oct. 17, 2006, both of which are herein incorporated in their entirety.

### FIELD OF INVENTION

A compact, multi-purpose tool for women.

### BRIEF DESCRIPTION OF THE DRAWINGS

FIG. 1 shows a top plan view of a first exemplary embodiment of the multi-purpose tool.

FIG. 2 shows a top plan view of a second exemplary embodiment of the multi-purpose tool.

### DETAILED DESCRIPTION

A compact, portable multi-tool entirely engineered for women from its size, aesthetic design to its functional aspects, it is designed to be used and carried by women. There are 3 different embodiments with different tools and implements to help with everyday projects at home, work and at play. All embodiments have a mechanism providing for easier access and use and preventing nail damage.

At least 1 embodiment will meet TSA restrictions. All embodiments will be made from stainless steel and will have a variety of colorful designs. One embodiment includes, but is not limited to including, pliers, corkscrew, flat nail clippers, nail file, extra small flat screwdriver, extra small phillips screwdriver, screwdriver, tweezer, scissor, flashlight, whistle, wire cutter with a ruler on the side.

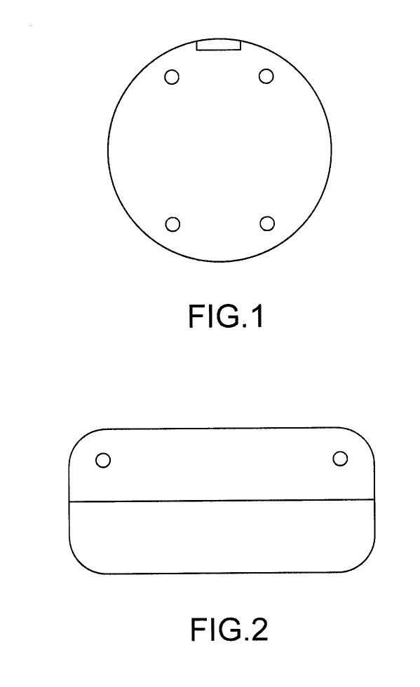

Another exemplary embodiment is a round compact hinged on one side with 4 pivot points. It has a mirror on one side, a compartment for needle and thread and safety pins or other discrete items, scissors, tweezers, nail clippers, flashlight, whistle, extra small phillips screwdriver, extra small flat screwdriver, nail file. It may include fewer elements than these and it may include additional elements not specifically listed. See FIG. 1.

Still another exemplary embodiment is rectangular shaped device with 2 separate sides. One side will have a hollow tube for discrete items. The other side will have 2 pivot points with whistle, flashlight, tweezer, nail clippers, scissors. A make-up brush may be included in the embodiment. It may include fewer elements than these and it may include additional elements not specifically listed. See FIG. 2.

Carrying cases will also sport different colors and patterns. We will also work with various purse and accessory manufacturers to design and develop carrying cases with various logos.

The multi-purpose tools can be carried in the purse, clipped to a purse or kept in the glove compartment.

What is claimed is:

1. A compact, portable multi-tool comprising:
a round top member;
a round bottom member;
at least one receptacle contained within at least one of the top and bottom members;
at least one pivot mechanism contained within said at least one receptacle; and
a hinge mechanism connecting the top and bottom members.

2. The compact, portable multi-tool of claim 1 further comprising at least one tool connected to the pivot mechanism.

3. The compact, portable multi-tool of claim 2 wherein said at least one tool comprises at least one of a scissors, a tweezers, a light, a nail clipper, a whistle, a brush, a screw driver, and a nail file.

4. The compact, portable multi-tool of claim 1 further comprising at least one tool removably contained within at least one of the receptacles.

5. The compact, portable multi-tool of claim 4 wherein said at least one tool comprises at least one of a scissors, a tweezers, a light, a nail clipper, a whistle, a brush, a screw driver, a nail file, a needle and thread, a straight pin, and a safety pin.

6. The compact, portable multi-tool of claim 5 further comprising a cover member for the receptacle.

7. The compact, portable multi-tool of claim 1 further comprising a mirror attached to at least one of the top and bottom members.

8. A compact, portable multi-tool comprising:
a round top member;
a round bottom member;
at least one receptacle contained within at least one of the top and bottom members; and
a hinge mechanism connecting the top and bottom members.

9. The compact, portable multi-tool of claim 8 further comprising at least one tool removably contained within at least one of the receptacles.

10. The compact, portable multi-tool of claim 9 wherein said at least one tool comprises at least one of a scissors, a tweezers, a light, a nail clipper, a whistle, a brush, a screw driver, a nail file, a needle and thread, a straight pin, and a safety pin.

11. The compact, portable multi-tool of claim 10 further comprising a cover member for the receptacle.

12. The compact, portable multi-tool of claim 8 further comprising a mirror attached to at least one of the top and bottom members.

13. The compact, portable multi-tool of claim 8 further comprising at least one pivot mechanism contained within at least one of the receptacles.

14. The compact, portable multi-tool of claim 13 further comprising at least one tool connected to the pivot mechanism.

15. The compact, portable multi-tool of claim 14 wherein said at least one tool comprises at least one of a scissors, a tweezers, a light, a nail clipper, a whistle, a brush, a screw driver, and a nail file.

16. A compact, portable multi-tool comprising:
a top member;
a bottom member;
at least one receptacle contained within at least one of the top and bottom members;
at least one pivot mechanism contained within said at least one receptacle; and
a hinge mechanism connecting the top and bottom members.

17. The compact, portable multi-tool of claim 16 further comprising at least one tool connected to the pivot mechanism.

18. The compact, portable multi-tool of claim 17 wherein said at least one tool comprises at least one of a scissors, a tweezers, a light, a nail clipper, a whistle, a brush, a screw driver, and a nail file.

19. The compact, portable multi-tool of claim 16 further comprising at least one tool removably contained within at least one of the receptacles.

20. The compact, portable multi-tool of claim 19 wherein said at least one tool comprises at least one of a scissors, a tweezers, a light, a nail clipper, a whistle, a brush, a screw driver, a nail file, a needle and thread, a straight pin, and a safety pin.

21. The compact, portable multi-tool of claim 20 further comprising a cover member for the receptacle.

22. The compact, portable multi-tool of claim 16 further comprising a mirror attached to at least one of the top and bottom members.
